(19) United States
(12) Patent Application Publication
(10) Pub. No.: US 2009/0304972 A1
(43) Pub. Date: Dec. 10, 2009

(54) Detachable Sheet

(76) Inventor: David A. Gluck, Tel Aviv (IL)

Correspondence Address: HAIM FACTOR;Ofek Group Inc., 16192 Coastal Highway, Lewes, DE, 19958, US

(21) Appl. No.: 12/093,736

(22) PCT Filed: Nov. 2, 2006
(86) PCT No.: PCT/IL06/01274

§ 371 Date: May 15, 2008

Related U.S. Application Data
(60) Provisional application No. 60/736,333, filed on Nov. 15, 2005.

(51) Int. Cl. B32B 3/00; B42D 13/00; B26D 3/08

(52) U.S. Cl. 428/43; 281/38; 83/879

(57) ABSTRACT

In one aspect, the present invention is directed to a sheet comprising: a first section on one side of the sheet; and a second section on the other side of the sheet and parallel to the first section; wherein the distance between the tip of the first section and the tip of the second section being substantially greater than zero, thereby upon applying a force along the tips, detaching the sheet between the tips. In another aspect, the present invention is directed to a sheet comprising: a section on one side of the sheet in which the shortest distance between the tip of the section and the un-sectioned edge of the sheet is substantially greater than zero, thereby upon applying a force along the section, detaching the sheet between the tip and the edge.

The present application claims priority from PCT/IL 2006/001274 application (publication number WO/2007/0578820) filed 2 Nov. 2006, claiming priority from U.S. Provisional Patent Application No. 60/736,333, filed Nov. 15, 2005, entitled “Means and methods for preventing visible perforation marks when detaching sheets from a notepad”, whose disclosures are incorporated by reference.

### FIELD OF THE INVENTION

The present invention generally relates to the field of press. More particularly, the invention relates to a detachable sheet which has reduced observable detachment marks, and a method and system for rendering such a detachable sheet.

### BACKGROUND OF THE INVENTION

FIG. 1 schematically illustrates a notepad, according to the prior art. Notepad 10 comprises a plurality of sheets 20. Sheets 20 are banded by binding means. In FIG. 1, the binding means are clamps 40, but other binding means can also be used, such as gluing.

The sheet 20 comprises a perforation line 30, for enabling tearing sheet 20 from notepad 10 over perforation line 30. Thus, perforation line 30 is aimed to provide two functions: to allow tearing the sheet more easily in comparison to a non-perforated sheet and thus enforcing the tearing line to be substantially at the perforation line.

FIG. 2 schematically illustrates an un-torn perforation line 30 of a sheet 20, according to the prior art. The perforation line 30 is comprised of sectioned regions 32 and non-sectioned regions 34. The non-sectioned regions 34 are “short” in order to enable “easy” tearing by a user. The shorter the non-torn region, the easier its tearing. The optimal length of the non-sectioned regions 34 (and the sectioned regions 32 as well) can be determined by experiment. It usually depends on the characteristics of the sheet, such as its thickness, the type of its fibers, and so forth.

FIG. 3 schematically illustrates sheet 20 of FIG. 2 after having been torn, according to the prior art. Tearing sheet 20 separates it into two parts: 20a, and 20b. As illustrated in FIG. 3, the torn perforation lines 30a and 30b are not uniform; thus, when tearing sheet 20 at perforation line 30, separated rims 30a and 30b are neither straight nor “homogeneous”.

Due to the non-esthetic nature of a sheet torn at a perforation line, a plurality of press products cannot be distributed as a notepad. For example, a business card necessarily must be esthetic as possible, and therefore business cards in the prior art are not distributed in a notepad form, but as separate entities which usually reside in a casing, generally a box.

Another implementation which cannot be embodied as a perforated sheet is a postcard featuring a landscape. Generally, landscape postcards are distributed as single entities, or in connection with a plurality of postcards.

Therefore, there is a long existing need for a sheet having greatly reduced, near unobservable detachment marks.

Other objects and advantages of the invention will become apparent as the description proceeds.

### SUMMARY OF THE INVENTION

In one aspect, the present invention is directed to a sheet comprising: a first section on one side of the sheet; and a second section on the other side of the sheet and parallel to the first section; wherein the distance between the tip of the first section and the tip of the second section being substantially greater than zero, thereby upon applying a force along the tips, detaching the sheet between the tips.

In one embodiment of the invention, the first section and the second section are rendered along the entire length of the sheet.

Preferably, the sheet is banded in a notepad.

The sheet may be of a business card, a postcard, a greeting card, a landscape card, and so forth.

In another aspect the present invention is directed to a method for rendering a sheet detachable, the method comprising the steps of: rendering a first section on one side of the sheet; and rendering a second section on the other side of the sheet parallel to the first section; wherein the distance between the tip of the first section and the tip of the second section is substantially greater than zero, thereby applying a force along the tips resulting with detaching the sheet between the tips.

In yet another aspect, the present invention is directed to an apparatus for rendering a sheet detachable, the apparatus comprising: a sectioning mechanism, for rendering a first section on one side of the sheet and optionally rendering a second section on the other side of the sheet and parallel to the first section; thereby upon applying a force along the tips, detaching the sheet.

In one embodiment of the invention, the sectioning mechanism comprises at least one blade, for rendering the sections.

The sectioning mechanism may comprise a supporting mechanism, for supporting the sheet, and/or a moving mechanism, for changing the position of the at least one blade with reference to the supporting mechanism, for rendering the sections.

Changing the position of the at least one blade with reference to the supporting mechanism may be carried out: by moving the at least one blade toward the sheet; by moving the at least one blade along the sheet; by moving the sheet toward the at least one blade; by moving the sheet along the at least one blade, and so on.

In yet another aspect, the present invention is directed to a sheet comprising: a section on one side of the sheet in which the shortest distance between the tip of the section and the un-sectioned edge of the sheet being substantially greater than zero, thereby upon applying a force along the section, detaching the sheet between the tip and the edge.

In yet another aspect, the present invention is directed to a method for rendering a sheet detachable, the method comprising the steps of: rendering a section on one side of the sheet, wherein the shortest distance between the tip of the section and the un-sectioned edge of the sheet being substantially greater than zero, thereby upon applying a force along the section, detaching the sheet between the tip and the edge.

In yet another aspect, the present invention is directed to a system for distributing a notepad having content such as business card and landscape postcard, the system comprising: a server accessible over the Internet, for accepting an order from a client to produce the notepad; a press machine, for printing the content on the sheets of the notepad; and a sectioning apparatus, for rendering a sheet detachable. The apparatus may comprise: a sectioning mechanism, for rendering a first section on one side of the sheet and optionally a second section on the other side of the sheet.

The system may further comprise a software application, for designing the content. The software application may be adapted to operate as a web page, to operate as a stand-alone program, and so forth.

### BRIEF DESCRIPTION OF THE DRAWINGS

Exemplary embodiments are illustrated in the referenced figures. It is intended that the embodiments and figures disclosed herein be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a notepad, according to the prior art.

FIG. 2 schematically illustrates an un-torn perforation line 30 of a sheet 20, according to the prior art.

FIG. 3 schematically illustrates sheet 20 of FIG. 2 after having been torn, according to the prior art.

FIGS. 4a and 4b schematically illustrate the way a perforation line is executed, according to the prior art.

FIGS. 5a, 5b and 5c schematically illustrate the way section lines are executed, according to a preferred embodiment of the invention.

FIG. 6 is a three-dimensional view of a sheet 20, which illustrates some terms used herein.

FIG. 7a is a sectional view of cross-section A-A of FIG. 6, according to a preferred embodiment of the invention. FIG. 7b is a sectional side-view of sheet 20 of FIG. 7a, after being torn. FIG. 7c is a top view of the torn sheet 20 of FIG. 7b.

FIG. 8a is a three-dimensional view of part 20b which has been detached from part 20a, according to a preferred embodiment of the invention. FIG. 8b is a three-dimensional view of the detached part 20b which has been turned upside-down, according to a preferred embodiment of the invention.

Each of FIGS. 9a to 9e schematically illustrate a cross-section (such as cross-section A-A of FIG. 6), according to embodiments of the invention.

FIG. 10 schematically illustrates an apparatus for rendering a sheet detachable, according to a preferred embodiment of the present invention.

FIG. 11 schematically illustrates an apparatus for rendering a sheet detachable, according to another preferred embodiment of the present invention.

FIG. 12 schematically illustrates a system for distributing a notepad of business cards, according to one embodiment of the invention.

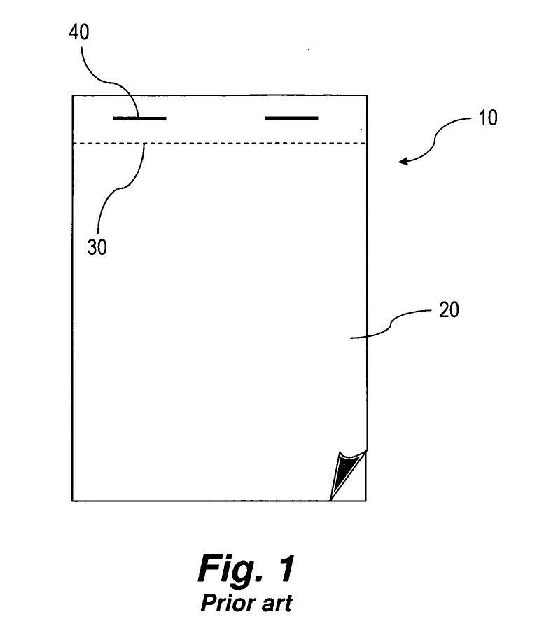

It will be appreciated that for simplicity and clarity of illustration, elements shown in the figures have not necessarily been drawn to scale. For example, the dimensions of some of the elements may be exaggerated relative to other elements for greater clarity. Further, where considered appropriate, reference numerals may be repeated among the figures to indicate corresponding or analogous elements.

### DETAILED DESCRIPTION OF PREFERRED EMBODIMENTS

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

### Generating a Perforation Line According to the Prior Art

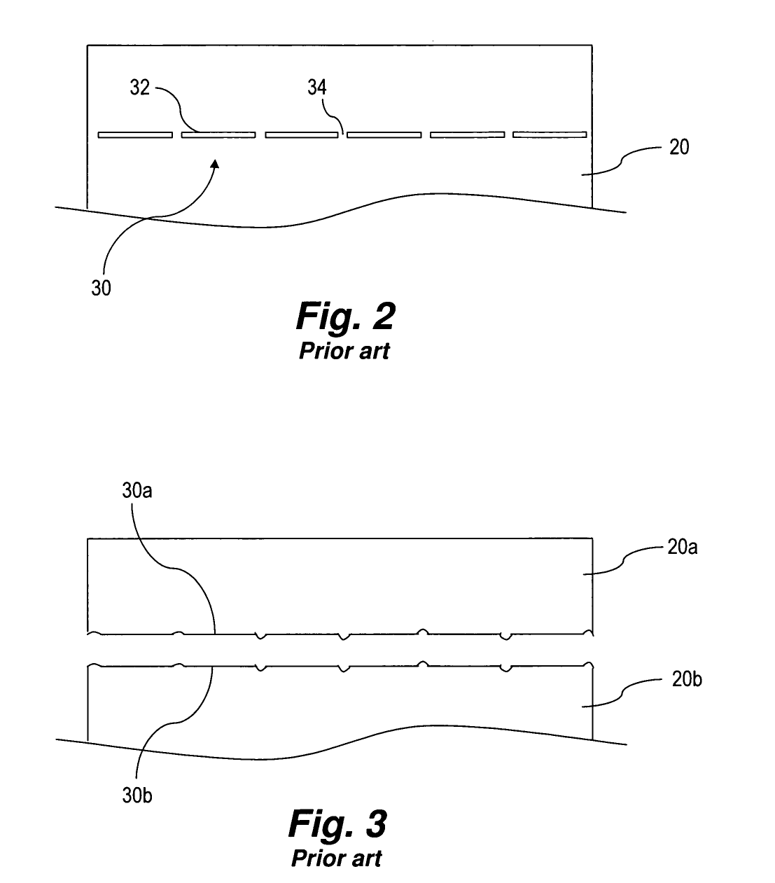

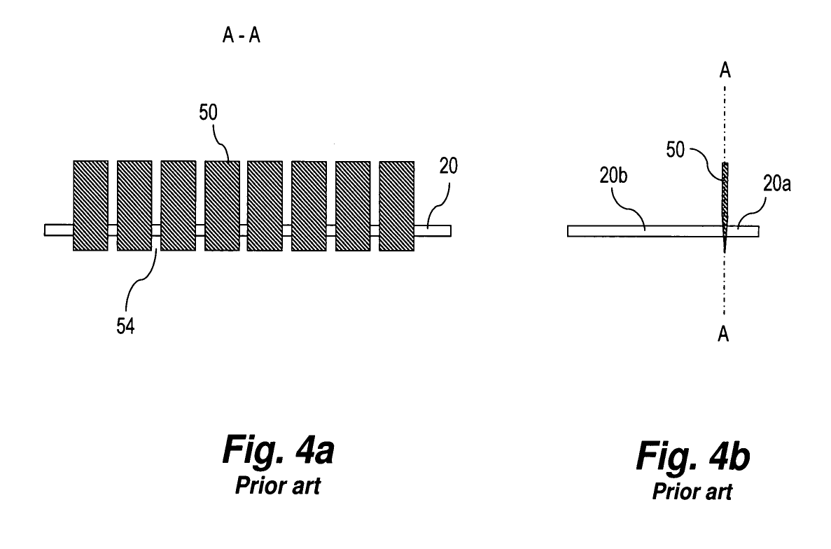

FIGS. 4a and 4b schematically illustrate the way a perforation line, such as line 30 of FIG. 2, is executed, according to the prior art. FIG. 4a is a cross-section along the perforation line, and FIG. 4b is a side cross-section thereof. FIG. 4a is section A-A of FIG. 4b.

The perforation line is executed by piercing sheet 20 with a group of blades 50. The result is a perforation line, such as line 30 of FIG. 2.

Each blade 50 of FIG. 4a corresponds to an executed section, such as section 32 of FIG. 2. A distance 54 separates two adjacent blades 50, resulting in non-sectioned regions, such as non-sectioned regions 34 of FIG. 2.

### Performing Section Lines, According to a Preferred Embodiment of the Invention

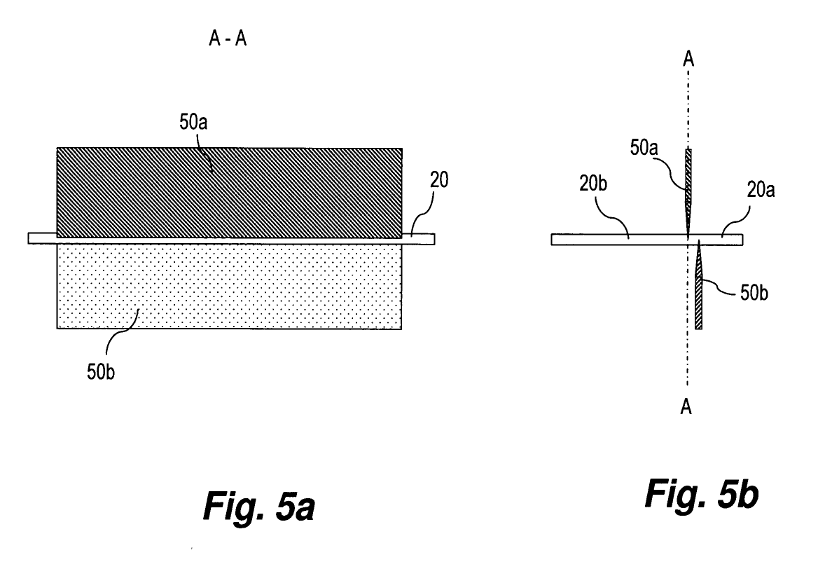

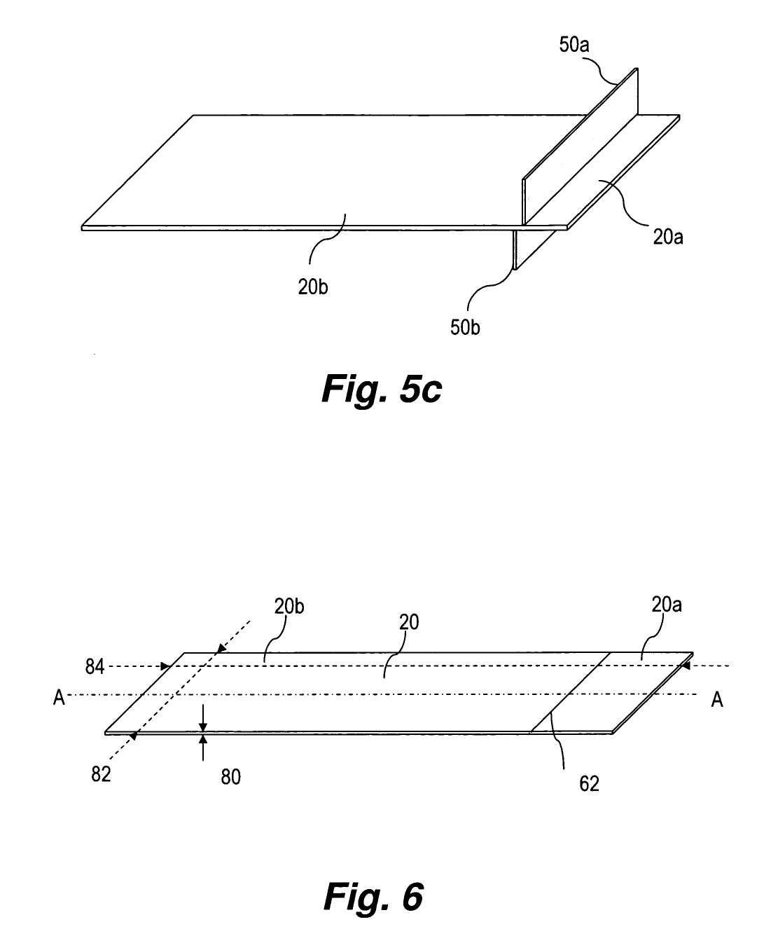

FIGS. 5a, 5b and 5c schematically illustrate the way section lines are executed, according to a preferred embodiment of the invention. FIG. 5a is section A-A of FIG. 5b. FIG. 5c is a three-dimensional view thereof.

As can be seen in FIG. 5a, there are two blades 50a and 50b, for executing two opposite sections along sheet 20: a first blade 50a for executing a section on one side of the sheet 20, and a second blade 50b, for executing a section on the other side of the sheet 20. The sectioning need not necessarily be carried out simultaneously. According to one embodiment of the invention, a section is carried out at one side of the sheet 20, and afterwards the sheet 20 is turned upside-down, and a section is carried out on the other side of the sheet 20.

FIG. 6 is a three-dimensional view of a sheet 20, which illustrates some terms used herein. The thickness of sheet 20 is marked as 80. The length of the sheet 20 is marked as 84, and the width of sheet 20 is marked as 82. Marker 62 denotes the section performed by blade 50a (of FIG. 5c). The “width” 82 of sheet 20 refers to the dimension of sheet 20 which is substantially parallel to the section line 62.

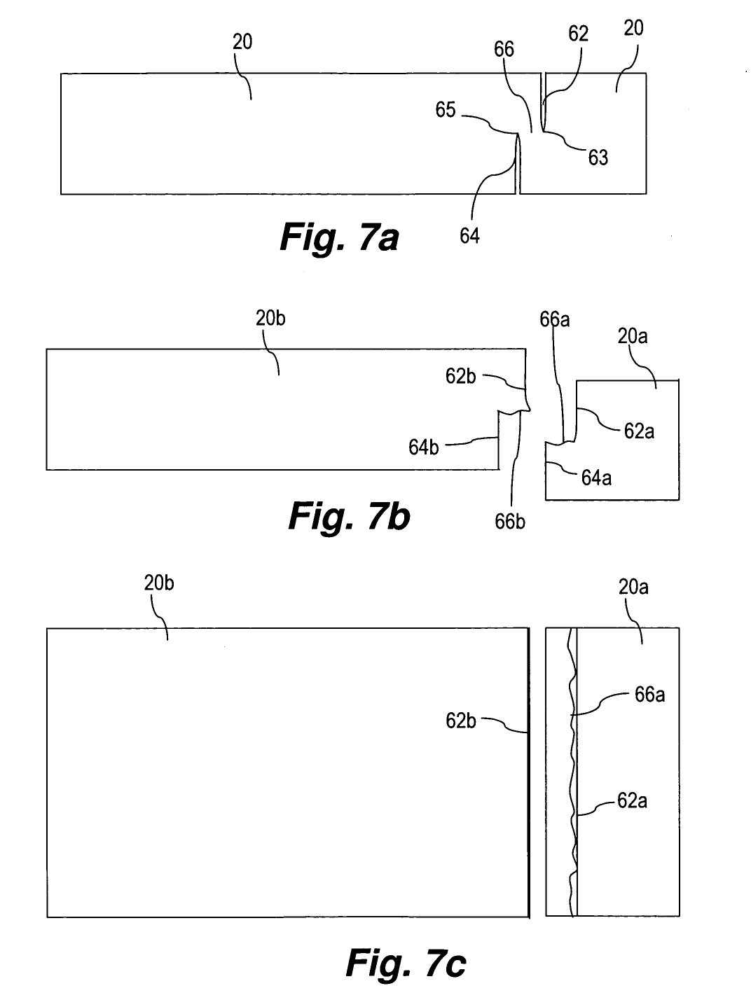

FIG. 7a is a sectional view of cross-section A-A of FIG. 6, according to a preferred embodiment of the invention. FIG. 7b is a sectional side-view of sheet 20 of FIG. 7a, after being torn. FIG. 7c is a top view of the torn sheet 20 of FIG. 7b.

Sheet 20 is sectioned by 62 and 64. Marker 66 denotes the “region” between tip 63 of section 62 and tip 65 of section 64. In other words, when it applies to a cross-section, marker 66 denotes an imaginary line between tips 33 and 35.

Upon applying a force along region 66, sheet 20 separates into two parts 20a and 20b at region 66, as illustrated in FIGS. 7b and 7c, especially if the distance between tips 63 and 65 is less than thickness 80 of sheet 20.

The applied force may be of a tearing nature (i.e., pulling parts 20a and 20b of the sheet 20 along line 66 in opposite directions), bending force, and so forth.

The imaginary line between tips 63 and 65 is marked herein as 66, and referred to as “separation region” (in a sectional view) or “separation line” (when it refers to the entire width of the sheet 20).

Reference is made now to FIGS. 7a, 7b and 7c. Upon tearing sheet 20 along separation line 66, sheet 20 separates into two parts, 20a and 20b. The separation region of part 20a along section 62 is marked as 62a, and its corresponding region of part 20b is marked as 62b. The separation region of part 20a along section 64 is marked as 64a, and its corresponding region of part 20b is marked as 64b. The separation region of part 20a is denoted as 66a. The separation region of part 20b is marked as 66b.

While edges 62a, 62b, 64a and 64b are a result of a section, regions 66a and 66b are the result of tearing, and therefore, while lines 62a, 62b, 64a and 64b have a “straight” and “homogeneous” outlook, the outlook of lines 66a and 66b is neither “straight” nor “homogeneous”. But, as illustrated in FIG. 7c, which is a top view of the torn sheet 20 of FIG. 7b, this defect is hidden in top-view. In other words, the torn region 66b is hidden. Although torn region 66b is visible, the meaningful part of sheet 20 is 20b, which may be a business card, a landscape postcard, and so forth, is hidden.

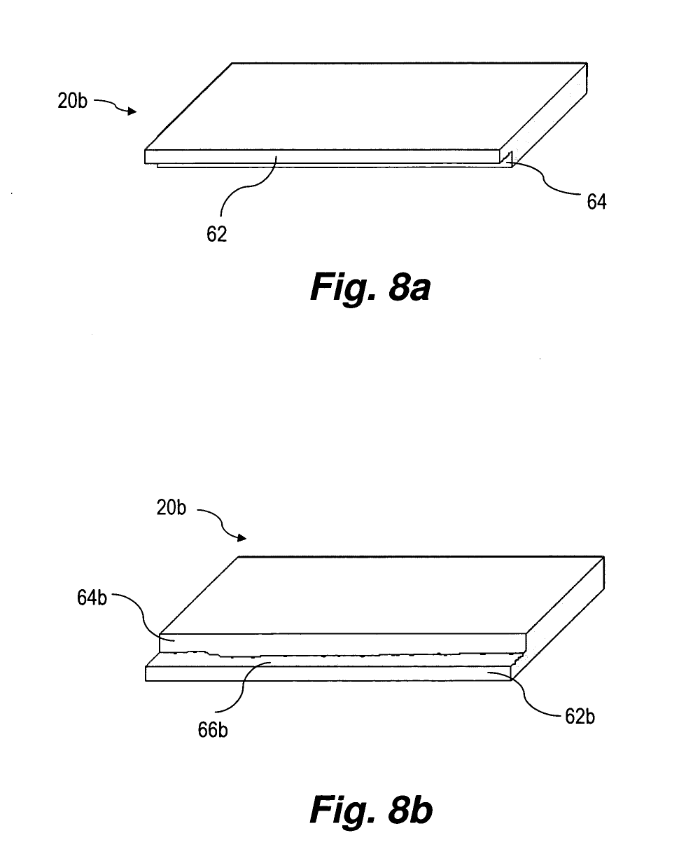

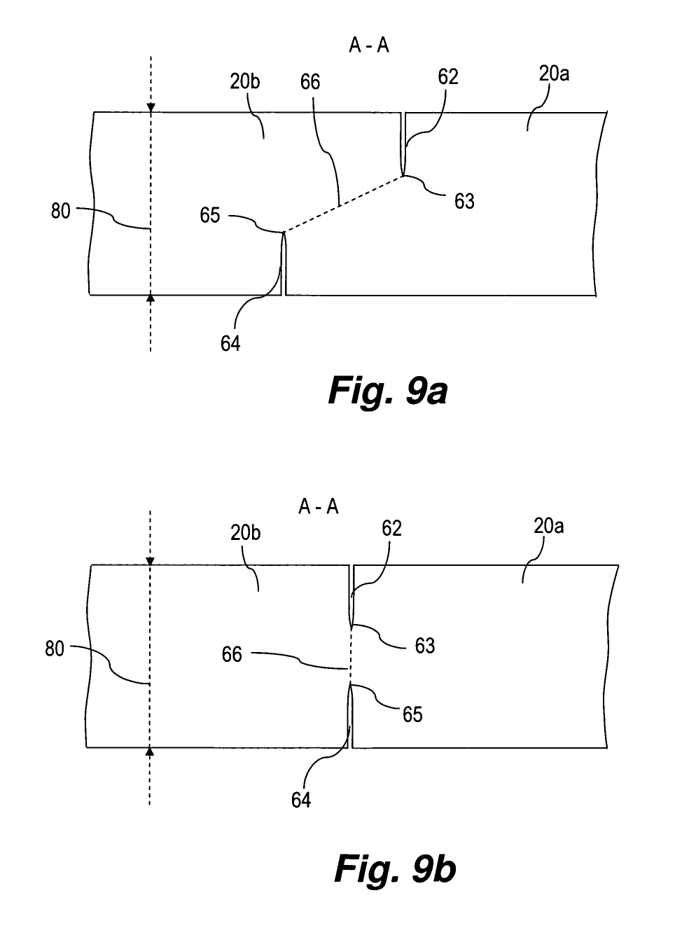

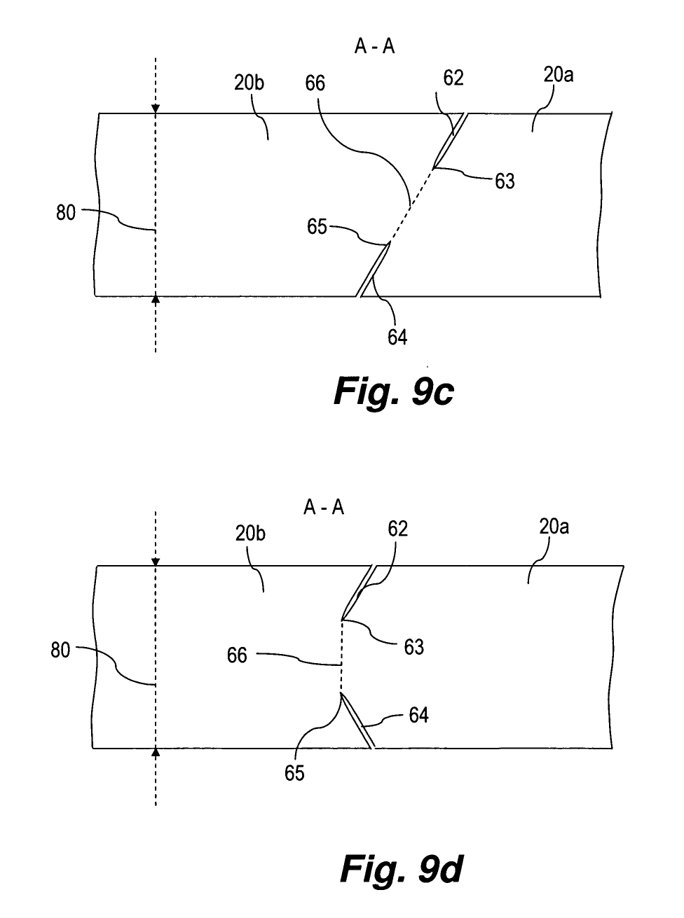

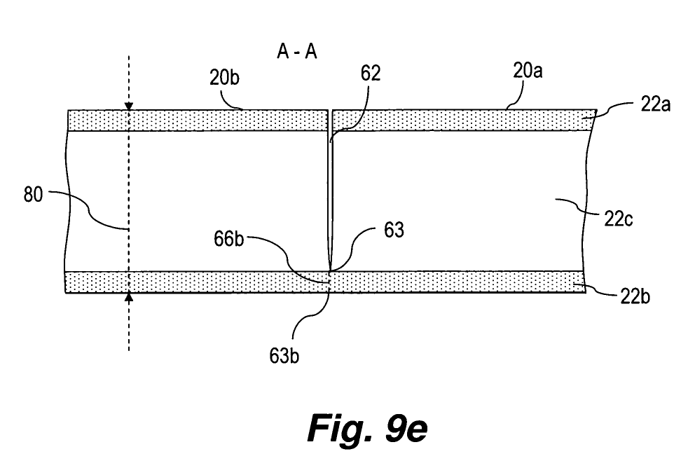

FIG. 8a is a three-dimensional view of part 20b which has been detached from part 20a, according to a preferred embodiment of the invention. FIG. 8b is a three-dimensional view of the detached part 20b which has been turned upside-down, according to a preferred embodiment of the invention.

As illustrated, while the torn line 66b is seen in the upside-down view of FIG. 8b, in FIG. 8a torn line 66b is hidden. The fact that the torn line is hidden from a top-view, all the edges of part 20b are therefore “straight” and “homogeneous”.

According to one embodiment of the invention, the sections are substantially parallel, thus leaving substantially the same distance between the tips of the sections. However, it should be understood that the sections do not necessarily have to be parallel.

### Sectioning Forms

Each of FIGS. 9a to 9e schematically illustrate a cross-section (such as cross-section A-A of FIG. 6), according to embodiments of the invention. In these embodiments, the depth of sections 62 and 64 constitutes about a third of the thickness of the sheet 20. However, this is only an example, and other proportions may be used, as well.

In the embodiment of FIG. 9a the planes of sections 62 and 64 are perpendicular to the plane of sheet 20, and therefore they are parallel each to other. However, the planes of sections 62 and 64 are not on the same plane. The advantage of this embodiment is that separation line 66 of a torn sheet is hidden from view from one side of the sheet, although it may be seen from the other side of the sheet.

In the embodiment of FIG. 9b, the planes of sections 62 and 64 are on the same plane. The drawback of this embodiment is that the separation line of a torn sheet is seen from both sides of the sheet.

In the embodiment of FIG. 9c, the planes caused by sections 62 and 64 are not perpendicular to the plane of sheet 20, but are on the same plane. The advantage of this embodiment is that the separation line of a torn sheet is hidden in view from one side of the sheet, although it is viewable from the other side of the sheet. Furthermore, since the sections are on the same plane but in opposite directions, both sections can be executed simultaneously.

In the embodiment of FIG. 9d the planes caused by sections 62 and 64 are not perpendicular to the plane of sheet 20, and not parallel each to one another. The advantage of this embodiment is that the separation line of a torn sheet is hidden from view from both sides of part 20b of the sheet.

The embodiment of FIG. 9e may be applied to a sheet which the fibers of its external layers 22a and 22b are more condensed than the fibers of its internal layer 22c. Such sheets are very common for business cards.

In this embodiment only one section is required, in contrast to the two sections required in the embodiments of FIGS. 9a to 9d. The section is marked as 62. The section 62 should not cut the entire layer 22c, but rather leave at least a part of the external layer 22b un-sectioned. The un-sectioned part is marked as 66b.

A bending force along the section line 62 results with breaking the sheet (into parts 20a and 20b along its section line 62 at the region between tip 63 of the section 62 to the nearest point at the edge of sheet 63b, i.e., line 66b). This is in contrast to the embodiments of FIGS. 9a to 9d in which the sheet is torn. Nevertheless in this embodiment the breaking line is straight and “homogeneous”, due to the nature of the fibers which the external layers of the sheet are made of.

As in the embodiments of FIGS. 9a to 9d, in the embodiment of FIG. 9e the section may be perpendicular to the sheet plane, or in an angle with the sheet plane.

A major advantage of this embodiment is that only one section is carried out in contrast to the embodiments of FIGS. 9a to 9d, and therefore the required work thereof diminishes.

A desired distance 66 (i.e., the distance between the lines of the rims 63 and 65 of the sections) may be determined by experiments. According to experiments carried out by the applicant, the desired distance 66 depends on characteristics such as the thickness of the sheet, the fibers of the sheet, the direction of the sections, and so forth.

Experiments carried out by the applicant of the present application for patent have indicated that in a paper sheet of XX gr. per squared meter, which is typical for business cards, sections of YY mm and a distance of ZZ mm between the tips of the sections produce easy tearing, with the tearing marks well hidden.

In the case of landscape postcards, which use a XX gr. per squared meter paper, sections of YY mm and a distance of ZZ mm between the tips of the sections produce easy tearing with the marks well hidden.

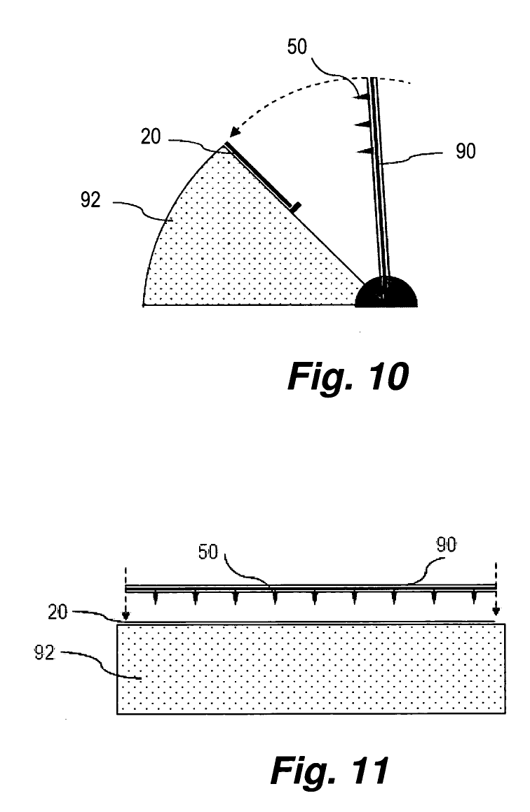

FIG. 10 schematically illustrates an apparatus for rendering a sheet detachable, according to a preferred embodiment of the present invention. FIG. 11 schematically illustrates an apparatus for rendering a sheet detachable, according to another preferred embodiment of the present invention.

The apparatus comprises:
a supporting mechanism 92, on which the sheet 20 is placed;
an approaching mechanism 90, for approaching the blades 50 to the sheet (or alternatively approaching the sheet to the blades); and
a feeder (not illustrated), for placing the sheet on the support mechanism, and removing the sheet 20 from the supporting mechanism.

In the embodiment of FIG. 10, the approaching mechanism 90 is based on rotational movement, while in the embodiment of FIG. 11, approaching mechanism 90 is based on linear movement. The movement lane is illustrated in FIGS. 10 and 11 as a dashed arrow.

As mentioned above, the approaching mechanism may approach the blades to the sheet, as illustrated on FIGS. 10 and 11, or approach the sheet to the blades (not illustrated).

Those skilled in the art will appreciate that feeders are well known in the art of press, and for the sake of simplicity they have not been illustrated in the figures herein.

In the embodiments of FIGS. 10 and 11 the operation of “punching” a sheet must be carried out twice: once for rendering a section on one side of the sheet, and afterwards on the other side of the sheet. Thus, when using the same apparatus for punching both sides of a sheet, the sheet has to be fed twice, the first for punching one side, and the second for punching the second side.

According to another embodiment of the invention, the sections of both sides of a sheet are carried simultaneously. A mechanism for rendering sections on both sides of a paper simultaneously, may be based on two approaching mechanisms, one for each side of the paper, and each having its own blades. Such a mechanism is not illustrated herein.

A section may be carried out by “punching”, as illustrated in FIGS. 10 and 11, by cutting (not illustrated), and so forth.

### A System for Distributing Detachable Business Cards

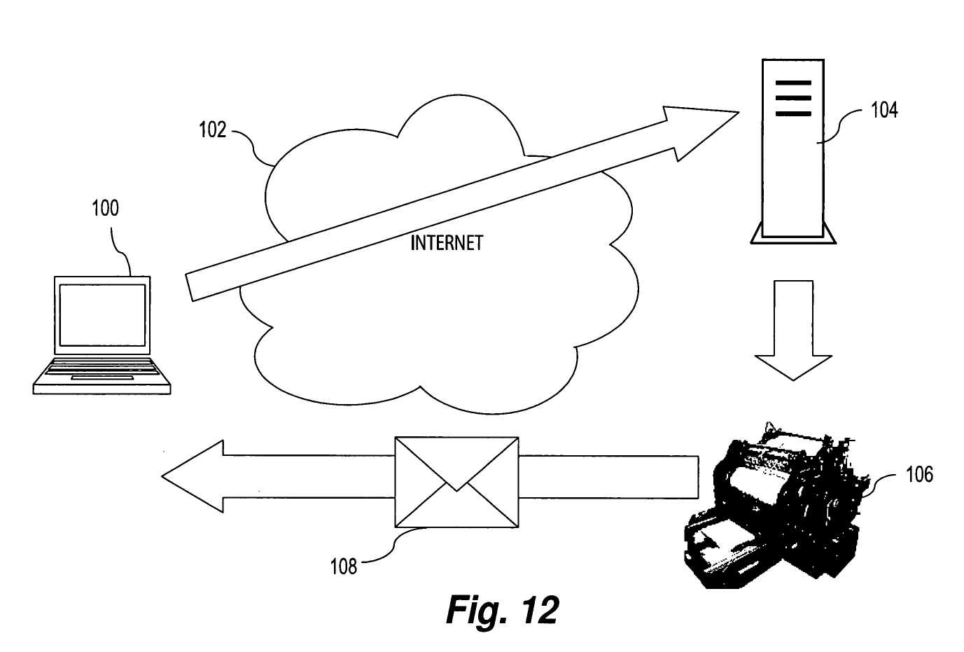

FIG. 12 schematically illustrates a system for distributing a notepad of business cards, according to one embodiment of the invention.

A user designs a business card using computer 100. This can be carried out by a program thereof, by a web site, and so forth. The design is sent via the Internet 102 to a server 104 of the press firm. The press firm produces notepads of business cards which are detachable according to the present invention, using machinery 106. The printed and detachable business cards are sent to the user via delivery means 108, such as mail, messenger, etc.

Business cards are only one example, and many other detachable press products may be distributed this way, such as landscape postcards, greeting postcards, and so forth.

While certain features of the disclosure have been illustrated and described herein, many modifications, substitutions, changes, and equivalents may occur to those skilled in the art. Those skilled in the art will appreciate that the invention can be embodied in other forms and ways, without losing the scope of the invention. The embodiments described herein should be considered as illustrative and not restrictive.

1. A sheet comprising:
a first section on one side of said sheet; and
a second section on the other side of said sheet and parallel to said first section;
wherein the distance between the tip of said first section and the tip of said second section being substantially greater than zero, thereby upon applying a force along said tips, detaching said sheet between said tips.

2. A sheet according to claim 1, wherein said first section and said second section are rendered along the entire length of said sheet.

3. A sheet according to claim 1, wherein said sheet is banded in a notepad.

4. A sheet according to claim 1, wherein said sheet is selected from a group comprising: a business card, a postcard, a greeting card, a landscape card.

5. A method for rendering a sheet detachable, the method comprising the steps of:
rendering a first section on one side of said sheet; and
rendering a second section on the other side of said sheet parallel to said first section;
wherein the distance between the tip of said first section and the tip of said second section is substantially greater than zero, thereby applying a force along said tips resulting with detaching said sheet between said tips.

6. A method according to claim 5, wherein said first section and said second section are along the entire length of said sheet.

7. An apparatus for rendering a sheet detachable, the apparatus comprising:
a sectioning mechanism, for rendering a first section on one side of said sheet and optionally rendering a second section on the other side of said sheet and parallel to said first section;
thereby upon applying a force along said tips, detaching said sheet.

8. An apparatus according to claim 7, wherein said sectioning mechanism comprises at least one blade, for rendering said sections.

9. An apparatus according to claim 7, wherein said sectioning mechanism comprises a supporting mechanism, for supporting said sheet.

10. An apparatus according to claim 7, wherein said sectioning mechanism comprises a moving mechanism, for changing the position of said at least one blade with reference to said supporting mechanism, for rendering said sections.

11. An apparatus according to claim 10, wherein said changing is carried out by moving said at least one blade toward said sheet.

12. An apparatus according to claim 10, wherein said changing is carried out by moving said at least one blade along said sheet.

13. An apparatus according to claim 10, wherein said changing is carried out by moving said sheet toward said at least one blade.

14. An apparatus according to claim 10, wherein said changing is carried out by moving said sheet along said at least one blade.

15. A system for distributing a notepad having a content, said system comprising:
a server accessible over the Internet, for accepting an order from a client to produce said notepad;
a press machine, for printing said content on the sheets of said notepad; and
a sectioning apparatus, for rendering a sheet detachable, said apparatus comprising: a sectioning mechanism, for rendering a first section on one side of said sheet and optionally a second section on the other side of said sheet.

16. A system according to claim 15, further comprising:
software application, for designing said content.

17. A system according to claim 16, wherein said software application is adapted to operate as a web page.

18. A system according to claim 16, wherein said software application is adapted to operate as a stand-alone program.

19. A system according to claim 15, wherein said content is of a group comprising: business card, landscape, greetings.

20. A sheet comprising:
a section on one side of said sheet in which the shortest distance between the tip of said section and the un-sectioned edge of said sheet being substantially greater than zero, thereby upon applying a force along said section, detaching said sheet between said tip and said edge.

21. A sheet according to claim 20, wherein said section is rendered along the entire length of said sheet.

22. A sheet according to claim 20, wherein said sheet is banded in a notepad.

23. A sheet according to claim 20, wherein said sheet is selected from a group comprising: a business card, a postcard, a greeting card, a landscape card.

24. A method for rendering a sheet detachable, the method comprising the steps of:
rendering a section on one side of said sheet, wherein the shortest distance between the tip of said section and the un-sectioned edge of said sheet being substantially greater than zero, thereby upon applying a force along said section, detaching said sheet between said tip and said edge.

25. A method according to claim 24, wherein said section is rendered along the entire length of said sheet.

26. A method according to claim 24, wherein said sheet is banded in a notepad.

27. A method according to claim 24, wherein said sheet is selected from a group comprising: a business card, a postcard, a greeting card, a landscape card.
